(19) United States
(12) Patent Application Publication
(10) Pub. No.: US 2012/0008784 A1
(43) Pub. Date: Jan. 12, 2012

(54) Delegated Key Exchange System and Method of Operation

(76) Inventor: Phillip Martin Hallam-Baker, Medford, MA (US)

(21) Appl. No.: 13/166,762

(22) Filed: Jun. 22, 2011

Related U.S. Application Data
(60) Provisional application No. 61/362,457, filed on Jul. 8, 2010.

(51) Int. Cl. H04L 9/08

(52) U.S. Cl. 380/278

(57) ABSTRACT

A cryptographic key exchange protocol that enables a device that does not have the capability to perform public key operations to securely establish a shared key with a host device without any information disclosing the key being revealed to the delegate key service.

### CROSS-REFERENCE TO RELATED APPLICATIONS

This application claims the benefit of U.S. Provisional Application No. 61/362,457, filed on 8^{th} Jul. 2010 under 35 U.S.C. 119(e), the entire contents of which are incorporated by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

The present invention is in the technical field of information security

More particularly, the present invention is in the technical field of cryptographic protocols for exchange of cryptographic keys.

### BACKGROUND

Cryptography permits strong guarantees to be provided with respect to the confidentiality, authenticity and integrity of communications. Providing such guarantees is of increasing importance in the field of automated control systems employing low cost, low performance devices.

The security of a cryptographic protocol invariably depends on the security of the cryptographic keys used to encrypt and authenticate protocol messages. There is thus a need for cryptographic protocols to exchange and establish such keys without the risk of disclosure or interference by a possible attacker. Such protocols are known as key exchange.

The form of key exchange typically preferred in a modern communication protocol employs the form of cryptography known as public key cryptography using techniques such as those taught by Diffie et. al. and Rivest et al. The core strength of these algorithms is the separation of the keys used to sign and decrypt messages from those used to verify and encrypt messages.

Public key cryptography offers considerable benefits to the protocol designer but requires significant computational resources to perform the necessary calculations with a key size sufficiently large to provide an acceptable degree of security. For this reason and others, cryptographic protocols almost invariably employ a mixture of public key and traditional techniques known as ‘symmetric key cryptography’.

The exponential improvement in computing performance since the discovery of public key cryptography has led many to assume that the processing demands of using public key cryptography will become less significant over time as low performance computers are replaced with faster ones.

While this assumption has indeed proved true of computers intended for personal use and for larger machines, it is not true of embedded computer systems where the prime consideration is cost. The same fabrication and design improvements that have made it possible to make high performance computers even faster have also made it possible to make low performance computers cheaper, thus enabling their use in an increasing number of applications. Embedded computer systems are now ubiquitous in electronic and electrical devices including children's toys, household appliances, vehicles and industrial control equipment. As a result the number of low performance computers has actually increased exponentially over time rather than decreasing.

Symmetric key cryptography alone has proved to be sufficient to support many large scale applications involving only two parties and where one of the parties is the provider of the authentication device. For example: ‘Subscriber Identity Modules’ (SIM) and equivalents in mobile telephones and subscriber identification cards used in satellite broadcasting.

While the protocols used to support such devices employ symmetric key cryptography as the basis for an authentication service, their purpose is to identify the device in which it is installed to the issuer alone. The protocols developed are thus essentially two party protocols designed to allow a secure communication between the issuer of the device and the holder of the device.

While such protocols could in theory enable communication between arbitrary communicating parties, doing so requires that the issuer be at least a potential intermediary in every such communication. The issuer of the device has all the information available to the device itself and is thus capable of impersonating the device in any context in which it is used.

In the general case the ability to perform such impersonation is highly undesirable both to the end user and the issuer of the device since it is an implicit third party in any communication purpose for which the device is employed.

Any party offering trusted third party services must limit their exposure to claims of liability, including unfounded claims. This in turn requires trusted third parties employ protocols and procedures that limit or eliminate their ability to commit a breach. Hitherto such protocols have required that all devices involved in the protocol perform public key cryptography operations.

There is thus a need for a cryptographic protocol that permits a low performance computing device to interact with networks and protocols while enabling the use of third party provided authentication services.

One approach to meeting this requirement is the use of a form of public key cryptography that places a lower computational burden on the endpoint device. For example certain variants of public key cryptography known as Elliptic Curve Cryptography (ECC) can offer an order of magnitude improvement in performance under certain conditions. While this is a useful improvement in some situations it is not a sufficient improvement to make implementation possible on the lowest performance devices.

A variation of this approach is to provide the device with special purpose hardware optimized for functions commonly used in cryptographic operations such as modular exponentiation. This approach is undesirable as it requires a significant increase in device complexity and the additional circuitry will be present in the device and drawing power for the lifetime of the device even though it will only actually be used on very rare occasions.

Another approach is to use symmetric key cryptography using a shared key that is configured into the device during deployment. This approach offers high security when done correctly but requires a significant commitment of effort and expertise.

Yet another approach that has been employed in the deployment of one-time-use authentication tokens such as that taught by Weiss is to install a secret into the device during manufacture and communicate the value of the secret to the end-customer by some out of band means.

While this approach is in use today in the field of authentication tokens it is deeply unsatisfactory as a general purpose key distribution scheme as the security of the scheme depends on the manufacturer maintaining the confidentiality of the embedded secret. This deficiency in the protocol poses a significant risk to the ultimate customer but an even greater risk to the manufacturer since it is required to act as a trusted third party.

### SUMMARY OF THE INVENTION

The present invention is a means of performing a secure cryptographic key exchange between a host and a device mediated by a service such that the device is not required to perform public key operations but the established key is nevertheless not disclosed to the service.

### BRIEF DESCRIPTION OF THE DRAWINGS

FIG. 1 shows an example application of the present invention in the field of home automation;

FIG. 2 shows the relationship between the communicating parties in the present invention; and

FIG. 3 shows an example protocol exchange employing the present invention;

### DETAILED DESCRIPTION OF THE INVENTION

In one embodiment, a device is initialized with a unique device identifier (ID) and device key (K_{D}) during manufacture. The device key should conform to all the requirements for use as a cryptographic key and the mode of distribution should ensure that at the end of the manufacturing process the device key is only stored in the device to which it is issued and the delegate key exchange service.

The protocol described allows a device that has a pre-established ID, K_{D} pair with a delegate key exchange service ‘service’ to establish a shared secret K_{DH} with a host computer, such that:
The Service cannot determine the value K_{DH} unless it also has access to both the original request made to the Service and the communication between the Device and the Host.
It is not possible to recover the value K_{DH} from knowledge of the communication between the Device and Host alone.
Any modification of the messages passing between the Device and the Host that would affect the value of K_{DH} calculated would result in the Device and Host arriving at different values of K_{DH} and the exchange would fail in a testable manner.

If the Service is operated in strict compliance with the requirements of the protocol, it is not possible for the Service to recover the value K_{DH} after the key establishment has been completed unless it has also previously observed the communication between the Device and the Host.

The trust guarantees offered to the parties may be further increased by use of mechanisms that ensure that the device keys are at all times protected by trustworthy, auditable hardware.

In an alternative embodiment the end user of the Device and Host might opt to further control their degree of risk by re-initializing devices previously configured for use with a Service of their own choice, typically one that is under their direct control.

### Application: Home Automation

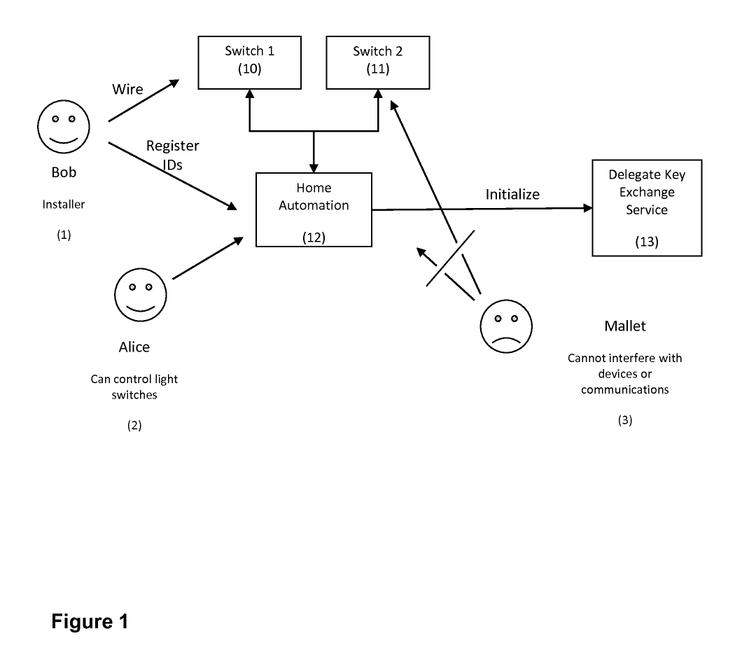

FIG. 1 shows an example of the protocol being employed in a home automation application.

Homeowner Alice (2) wishes electrician Bob (1) to deploy a home automation system in her house so that she can turn the lights (10, 11) on and off in the television room without getting up from her chair. For reasons of cost the home automation system (12) must not require additional wiring to be laid and control signals must therefore be passed either wirelessly or through the power line. While existing products meet this specific need, their lack of security means that the lights in Alice's house could be accidentally activated by Carol living next door or deliberately and maliciously by attacker Mallet (3).

An approach using public key cryptography as the device authentication means would require each device controller to have the ability to perform public key cryptography operations and thus be more expensive. An approach using symmetric key cryptography alone would require Alice and Bob to either engage in complex key management operations or to accept disclosure of their cryptographic keys to a third party.

The delegate key exchange scheme allows Bob to install the home automation devices with minimal changes to his working practices. The device is wired in precisely the same way as a traditional power socket or light switch. Each device is marked with a unique identifier (for example, a serial number). Bob makes a note of each identifier (for example, by using a barcode reader or writing it down) and enters them into the home automation controller system which contacts the Delegate Key Exchange Service (13) on his behalf to complete the key exchange. From this point on the configuration and initialization of the device is automatic.

### Application: Control System Deployment

Delegated Key Exchange may be employed in other forms of control system application, including industrial plant control, industrial plant automation, robotics and automotive vehicles.

### Application: Authentication Token

Delegated Key Exchange may be employed in the context of a card or token based authentication schemes.

The authentication token (for example an ISO/IEC 7810 compliant smartcard) is initialized with a symmetric keypair during manufacture. On deployment the card is initialized with a site specific symmetric keypair by means of the Delegated Key Exchange protocol.

### Protocol

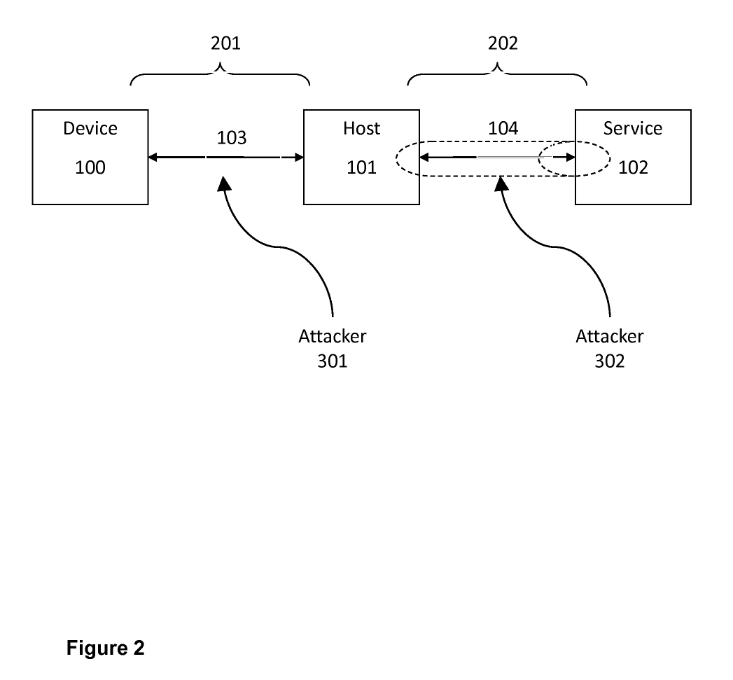

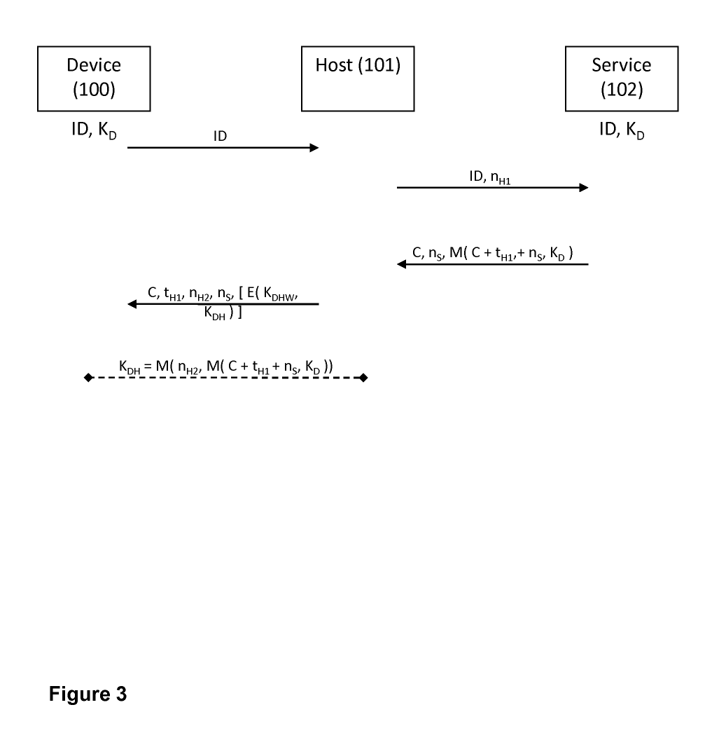

The protocol consists of four messages of which the last three contain the cryptographic elements. The protocol configuration is shown in FIG. 2. A timing diagram for the protocol is given in FIG. 3.

The parties to the protocol are a Device (101), a Host (101) and a Service (102).

Communication between the Device and Host (201) would be achieved using whatever physical and messaging protocols are supported by the device. For example RS 485 in combination with MODBUS or DNP3. The security of the protocol does not depend on the communication between the Device and Host being protected against non-disclosure. Indeed it is assumed that the lack of such protection is the problem that the invention is deployed to solve.

Communication between the Host and Service (202) must be protected to prevent disclosure. This may be achieved using a secure tunnel protocol such as SSL/TLS or IPSEC. In an alternative embodiment the cryptographic elements are directly protected using the public key of the Host and Server. In yet another alternative embodiment, the communication between the Host and Service are secured by a session key established out of band.

### Cryptographic Operations

The protocol employs a Message Authentication Code function M (c, k) where c is the content and k the key. For example HMAC-SHA2 may be used.

The protocol also employs a cryptographic digest function M(c) where c is the content. For example, SHA-2 may be used.

Concatenation of content data values is represented using the +operator.

The protocol does not require that the combination of the data items be achieved through concatenation or that they be presented in a particular order, only that the combination function and the order chosen be consistent. Equivalent embodiments of the protocol may be devised by altering the order in which the data elements are combined, the combination function and/or the cryptographic algorithms.

The protocol requires nonce values (n_{H1}, n_{H2}, n_{S}) to be generated by the Host and Service.

Nonce values may be generated through a wide variety of equivalent means. A cryptographically qualified random data source may be used. In an alternative embodiment a pseudo-random sequence may be used.

### Initial Conditions

At the start of the protocol the values ID and K_{DM} are known to both the Device and the Service. They should not be disclosed to any other party, nor should any other party keep a record of them.

### Device to Host

In the first step of the protocol the Device communicates its unique identifier to the Host.

Since this is the only information the Host requires to initiate the protocol, the Device to Host message may be performed out of band, either as part of a prior network communication (e.g. network address acquisition) or even a communication with the device supplier prior to the physical device itself being acquired.

Although the protocol intentionally avoids the use of a device nonce, such a nonce could be introduced in an equivalent variation.

### Host to Service

The Host communicates the values ID and n_{H1} to the Service where n_{H1} is a nonce value.

### Service to Host

On receiving the request from the Host, the Service determines if it holds a corresponding key value. If not, an error is reported and the protocol stops. If required, the Host may perform access control operations at this point, dependent on the credentials presented by the Host.

The protocol makes use of a context value C. In the simple version of the protocol the value C is simply the device identifier ID. In the advanced form of the protocol the value C is calculated from the cryptographic credentials used to secure the communication between the Host and Service.

The Service now generates a nonce value n_{S} and calculates the values t_{H1} and m as follows:

t_{H1}=H(n_{H1})

m=M(C+t_{H1}+n_{S},K)

The Service communicates the values n_{S} and m to the Host.

In order to preclude the possibility of future collusion in an attack, the Service should delete all copies of the values n_{H1} and m after the message has been sent to the host. If this form of attack is not a concern, it is not necessary to calculate t_{H1} and the value n_{H1} may be used in its place to calculate m.

### Host to Device

The Host now generates a nonce value n_{H2} and calculates the value K_{DH} as follows:

K_{DH}=M(n_{H2},m)

The Service now completes the protocol by communicating the values t_{H1}, n_{H2} and n_{S} to the Device.

The Device may now calculate the value K_{DH} using the same formula as the Host.

### Alternative Protocol

Additional protections may be provided with only a modest increase in computational cost by modifying the choice of context value C so that it is dependent on the cryptographic credentials used to authenticate the server and extending the Host to Device communication to provide the Device with sufficient information to determine C.

For example, if the Server credential is C_{S}, a realization of the protocol may require the value C to be determined as:

C=ID+C_{S}

Provided the Server will only use values of C created from authentic credentials C_{S}, the protocol is protected against a man-in-the-middle attack.

In practice a preferable derivation is the form C=H(ID+C_{S}) since this ensures that the size of the message to the Device is independent of the size of the credential.

The value C may be made dependent on any set of data values that are to be securely bound to the established cryptographic key. For example, the time the request is made, or the identity of the party making the request.

The same principle may be applied to communication between the Device and Host to achieve attestation of any properties of the Device and/or the Host.

In this configuration the value K_{DH} is calculated as:

K_{DH}=M(D,m)

Where the value D is dependent on the parameters to be verified. Such parameters much of course be available to both the Device and the Host through in-band or out-of band communication.

For example, a common requirement is for the host to be able to determine which firmware, application code or configuration data is in use in the device. In this instance the value D might be calculated as:

D=H(n_{H2}+H(f)) where f is the firmware image

### Equivalent Embodiments

While the foregoing written description enables a practitioner of ordinary skill in the art to make and use one instance of the protocol, those of ordinary skill will understand and appreciate the existence of variations and equivalents of this specific embodiment, method and examples described.

In particular;

### Equivalent Cryptographic Functions

In the described embodiment of the protocol a Message Authentication Code (MAC) function is used to perform a one-way function under control of a key. In an equivalent implementation a simple one-way function over the content concatenated with or otherwise modified by the key may be employed.

Where use of a cryptographic digest function is specified, an equivalent implementation may be replaced with a MAC function combined with any choice of key.

### Wrapped Key

In some situations it is desirable for the Host to have the ability to select the shared secret key. For example to enable the use of keys generated from the device identifier or other identifier by means of a master secret key.

This capability may be added to the protocol by encrypting the desired shared secret under the value K_{DH} and including the result in the final message from the Host to the Device.

### Multiple Services

A party with serious security concerns might choose to further limit reliance on one specific Delegated Key Exchange Service by employing multiple services.

In one instance of this variation, a shared key established through a key exchange employing one Service is used to encrypt communication between the Device and Host in a second key exchange employing the second service.

In an alternative instance of this variation, the Device and Host establish multiple shared keys through key exchanges with the independent Services and the final key is created by means of a combination function on the set of shared keys. For example the shared key K_{DH} might be formed from K_{DH1}, K_{DH2} as K_{DH}=K_{DH1} XOR K_{DH2} or K_{DH}=H (K_{DH1}+K_{DH2})₅ or any equivalent combination with the necessary cryptographic properties.

### Multiple Constrained Devices

The protocol as described allows a constrained Device to establish a session key with a Host that is not constrained in processing resources. The protocol may be generalized to allow a session key to be established between two constrained devices.

One method of establishing a session key between two constrained devices is for the Host to perform an independent key establishment operation with each constrained device and then issue a session key to the constrained devices. This mode of use may be regarded as a combination of the present invention with a Needham-Schroeder key distribution mechanism with the Host performing the role of the key distribution center.

Another method of establishing a session key is for the constrained devices to interact directly. Numerous equivalent variations of this approach are possible.

### Public Key Exchange

In the case where it is desirable for no party other than the Host and Service to have any possibility of calculating the established session key, the value K_{DH} may be used to authenticate a lightweight Diffie-Helleman key exchange following completion of the delegated exchange protocol.

### Derived Key

While the Device Identifier and Device Key are logically independent, manufacturing efficiencies may be realized by employing techniques which allow the shared secret to be derived from the device identifier by means of a cryptographic operation and a secret key.

For example the Device Key may be derived as K_{DH}=E (ID, k₁) or K_{DH}=MAC (ID, k₂) where k₁ and k₂ are secret keys known only at the point of manufacture and the registry. Use of such cryptographic techniques enables communication between the manufacturer and the registry to be minimized, a key requirement in very high volume manufacturing operations.

Ideally the scope of use for the secret keys should be minimized to limit exposure in case a compromise does occur. For example a machine testing and configuring a million devices a week might be required to change encryption keys every 10,000 devices so that a compromise such as the theft of the configuration device would in the worst case require the replacement of the devices initialized using the last encryption key rather than every device ever configured by that machine.

### Extended Applications

The basic key exchange protocol may be used to benefit a wide range of applications.

### Interchangeable Identity Module

A key problem in manufacture of electronic devices is how to program each device with a unique identity code. Mass production techniques are optimized for the production of devices that are precisely the same. Programming of cryptographic keys offers a challenge that is harder still, not only is the data to be unique, the data must not be disclosed to any unauthorized party.

Meeting such constraints in the general purpose supply chain is time consuming and costly relative to the cost of the devices themselves. If the key is to be considered trustworthy, the key must be installed in a manufacturing facility that is accredited as trustworthy.

Implementation of the present invention in a separate, single purpose identity module allows both of these considerations to be met at very little cost. Instead of having to manufacture and customize the whole device in a trustworthy facility, only the interchangeable identity module need be so produced.

One form of such an interchangeable identity module would contain a CPU, memory and communication means packaged in an interchangeable package format such as a dual-in-line (DIL) socket or SIM format. Such a device may employ a standardized interface protocol such as Serial Peripheral Interface Bus or Inter-Integrated Circuit (I²C)bus for communication.

If an end-user wishes to employ a commercial off-the-shelf device manufactured for use in applications requiring a normal degree of trustworthiness for an application requiring a higher degree of trust they can do so by replacing the interchangeable identity module provided by the supplier with a different one from a trusted provider. If the highest level of assurance is required, a low cost generic Interchangeable Identity Module may be replaced with one produced in a trusted facility and additionally capable of supporting public key operations, thus enabling use of a key exchange supporting perfect forward secrecy.

Use of Interchangeable Identity Modules provide another important advantage when equipment is being decommissioned. Removal and destruction of the Interchangeable Identity Module assures the end user that the ability of the device to access their network has been completely eliminated.

### Wireless Identity Module

The present invention may be used as the basis of an improved wireless identification device also known as a Radio Frequency Identification Device (RFID).

Currently existing RFID tags are vulnerable to compromise at the registry unless higher cost, Public Key based authentication techniques are employed.

The present invention allows a low cost RFID token without public key capability to be cryptographically ‘tied’ to a specific zone of trust and to perform secure communications within that zone of trust without the risk of compromise by the token manufacturer or registry service provider.

### Theft Deterrence

The present invention may be used as the basis of a theft prevention system in which the device refuses to perform part or all of its function unless the device is provided with periodic proof of possession of a shared key established through use of the protocol.

For example, an LED light bulb is configured with a device key during manufacture. On deployment the end user performs the protocol previously described (or a variant thereof) to establish a shared secret key K_{DH}. At this point the Service is advised that all requests for re-key operations for that device are to be refused except by express permission of that end user. The device is then instructed to refuse requests to provide illumination unless that request is authenticated by means of the shared secret key K_{DH}.

While such a device is still vulnerable to theft, there is no advantage to a thief in doing so as the device can only be used by an end-user with knowledge of the shared secret key K_{DH}.

The present invention may be applied to prevent theft of all manner of electronic devices that require access to a computer network for at least a part of their function or are composed of multiple interchangeable components. Such devices include lenses and accessories for photographic and video systems, automotive accessories as car radios and mobile telephones.

What is claimed is:

1. A method of managing cryptographic keys between first and second parties with the assistance of a third party comprising:
the third party or an agent thereof establishing a device identifier value and device key value in the first party
the second party determining at least one device identifier corresponding to the first party, and
the second party making a request to the third party that includes at least the device identifier, and
the third party chooses a nonce value, and
the third party calculates a message value m as a function of at least the device key corresponding to the device identifier and the nonce value, and
the message value m is returned to the second party, and
the second party communicates all the data necessary to calculate m together with a nonce value to the first party, and
the second party calculates the session key k as a function of m and the nonce value, and
the first party calculates the session key k from the data provided by the second party, the device identifier and device key.

2. The method according to claim 11 in which the calculation of m is derived by first applying a one way function to the value of the nonce provided by the second party.

3. The method according to claim 1 in which the message from the second party to the first party further includes an additional nonce value that is used in the calculation of the session key k as a function of m.

4. The method according to claim 33 in which a one way function is used to derive m

5. The method according to claim 44 in which the one way function is a Message Authentication Code

6. The method according to claim 33 in which the session key is calculated using a one way function.

7. The method according to claim 66 in which the one way function is a Message Authentication Code

8. The method according to claim 77 in which the input to the one way function includes a device context.

9. The method according to claim 88 in which a Message Authentication Code is used to derive m.

10. The method according to claim 88 in which the device context further includes a value that depends on at least a part of the firmware of the device.

11. The method according to claim 1 in which the request from the second party to the third further includes a context value.

12. The method according to claim 1111 in which the communication between the second party and the third party employs a cryptographic communication protocol.

13. The method according to claim 1111 in which the cryptographic communication protocol employs a credential for the third party and at least a part of the credential forms at least a part of the context value.

14. The method according to claim 1111 in which the cryptographic communication protocol employs a credential for the second party and at least a part of the credential forms at least a part of the context value.

15. The method according to claim 1414 in which the cryptographic communication protocol is Transport Layer Security (also known as Secure Socket Layer) and the credential is an X.509 Certificate.

16. The method according to claim 88 in which the second party uses the session key k derived from m to encrypt a second session key k2 that is passed to the first party.

17. The method according to claim 88 in which the first party has embedded device identifier value and device key value established by multiple third parties and the second party may engage in the method described one time or more times with one third party or multiple third parties.

18. The method according to claim 11 in which the device key is generated as a cryptographic function of the device identifier.

19. The method according to claim 1818 in which the cryptographic function is an encryption function.

20. The method according to claim 1818 in which the cryptographic function is a Message Authentication Code function.

21. A device of manufacture that manages cryptographic keys in conjunction with a second party with the assistance of a third party comprising:
the third party or an agent thereof establishing a device identifier value and device key value in the first party
the second party determining at least one device identifier corresponding to the device, and
the second party making a request to the third party that includes at least the device identifier, and
the third party chooses a nonce value, and
the third party calculates a message value m as a function of at least the device key corresponding to the device identifier and the nonce value, and
the message value m is returned to the second party, and
the second party communicates all the data necessary to calculate m to the first device, and
the second party calculates the session key k as a function of m, and the device calculates m, and
the first party calculates the session key k from the data provided by the second party, the device identifier and device key.

22. The device according to claim 2121 in which the first device is packaged as a removable module

23. The device according to claim 2121 in which the device is incorporated into a home automation system.

24. The device according to claim 2121 in which the device is incorporated into a process control system

25. The device according to claim 2121 in which the device is an authentication token.

26. The device according to claim 2121 in which the device communicates with the second party by means of a wireless means communication.

27. The device according to claim 2626 in which the device is a Radio Frequency Identification Device.

28. The device according to claim 2121 in which the first device is further configured to refuse some or all operation requests unless authenticated by means of the session key k.

29. The device according to claim 2121 in which the first device is further configured to refuse some or all operation requests unless provided with a proof of possession of the session key k within a pre-determined time interval.

30. The device according to claim 29 in which the device is an interchangeable module for providing illumination.

31. The device according to claim 29 in which the device is a lens, light, strobe light or other accessory for a camera.
